(19) United States
(12) Patent Application Publication
(10) Pub. No.: US 2009/0024922 A1
(43) Pub. Date: Jan. 22, 2009

(54) METHOD AND SYSTEM FOR SYNCHRONIZING MEDIA FILES

(76) Inventors: DAVID MARKOWITZ, Modiin (IL); Ben Enosh, Tel Aviv (IL); Jonathan Silberberg, Jerusalem (IL); Yuval Klein, Modiin (IL); Michael Dotan, Tel Aviv (IL)

Correspondence Address: FOLEY & LARDNER LLP, 150 EAST GILMAN STREET, P.O. BOX 1497, MADISON, WI, 53701-1497, US

(21) Appl. No.: 11/768,656

(22) Filed: Jun. 26, 2007

Related U.S. Application Data
(60) Provisional application No. 60/834,217, filed on Jul. 31, 2006.
(60) Provisional application No. 60/825,275, filed on Sep. 12, 2006.

(51) Int. Cl. G06F 3/048; G06F 12/00

(52) U.S. Cl. 715/716; 707/201; 707/104.1; 715/748; 707/E17.01; 707/E17.008

(57) ABSTRACT

A method of and a system are provided for enhancing a source media file with additional content by combining one or more layer media files with the source media file. The user can view the media files synchronized together on a user's computing device which is distinct from the computing device on which either or all of the media files are stored. The integrity of the source media file is not changed. A reference value for a reference parameter associated with presentation of the media files together is used to synchronize the media files “on the fly” as the media files are received at the user's computing device.

### CROSS-REFERENCE TO RELATED APPLICATIONS

This application claims the benefit of U.S. Provisional Patent Application Ser. No. 60/834,217 that was filed Jul. 31, 2006, the disclosure of which is incorporated by reference in its entirety, and of U.S. Provisional Patent Application Ser. No 60/825,275 that was filed Sep. 12, 2006, the disclosure of which is incorporated by reference in its entirety.

### FIELD

The field of the disclosure relates generally to media players. More specifically, the disclosure relates to the streaming and synchronization of a plurality of media files viewed as a single media file

### BACKGROUND

Currently, various products allow users to comment or to critique existing videos displayed or transmitted via the Internet. Some of these products allow a user to comment in a predetermined area specified by the provider. Generally, the predetermined area is located outside of the video itself and is not related to a specific moment or frame of the video. Other products allow a user to edit video and create comments or text on the video relative to a specific moment or frame. In general, these products alter the original video file. It is important to maintain the integrity of the original creator's ideas and concepts by not altering the original video file, while allowing for comments or additional content from different users. Other products allow a user to define comments or to edit content without altering the original video file by superimposing the user's comments/edits onto the original file as a layer. All of these products, however, require a user to edit the video file where the original file resides. Thus, a method or system which allows a user to retrieve an existing video file from one source, to retrieve a second file comprising video, audio, and/or textual content from another source, and to view both media files together at a different computing device is needed.

Currently, a variety of media players allow users to view media files at a computing device. Most media players do not allow a user to play multiple sources of information or content as overlays to a source media file. Regardless of whether or not these media players support the playback of multiple files as overlays to a source media file, it is important that the multiple files are played in synchronization so that information in the media file containing a layer appears at the correct time or frame defined by the layer creator. Current video synchronization methods broadcast al of the related information as one file or broadcast in such a way that a viewer receives all of the information and content together. The synchronization of two or more content sources is performed by the broadcaster and sent to the viewer as a single broadcast. While the viewer may have the option to enable or disable the display of some or all of the additional information (i.e., closed captioning in a broadcast can be enabled or disabled), the broadcast is received by the viewer with all of the information included. In addition, the synchronization process is performed and completed at the source of the broadcast and not at the time the broadcast is viewed by a viewer. Additionally, current systems are not designed to allow for user-generated content to be added post production. Thus, what is needed is a method and a system for synchronization of multiple media files so that the multiple files can be viewed either together or independently from one another. What is further needed is a method and a system for synchronizing the files “on the fly”, that is, at the time when the multiple files are being viewed by a viewer and not prior to transmission of the files.

### SUMMARY

A method and a system for presentation of a plurality of media files are provided in an exemplary embodiment. The plurality of media files can be selected from one or more source locations and are synchronized so that the media files can be viewed together or can be viewed independently from one another. The synchronization process is done “on the fly” as the files are received from the one or more source locations.

In an exemplary embodiment, a device for synchronizing a plurality of media files is provided. The device includes, but is not limited to, a communication interface, a computer-readable medium having computer-readable instructions therein, and a processor. The communication interface receives a first media file The processor is coupled to the communication interface and to the computer-readable medium and is configured to execute the instructions. The instructions are programmed to present a second media file with the first media file; while presenting the second media file with the first media file, compare a first reference parameter associated with the first media file to a second reference parameter associated with the second media file, and control the based on the comparison to synchronize the second media file and the first media file.

In another exemplary embodiment, a method of synchronizing a plurality of media files is provided. A first media file is received from a first device at a second device. A second media file is presented with the first media file at the second device. While the second media file is presented with the first media file, a first reference parameter associated with the first media file is compared to a second reference parameter associated with the second media file. The presentation of the second media file with the first media file is controlled based on the comparison to synchronize the second media file and the first media file.

In yet another exemplary embodiment, computer-readable instructions are provided that, upon execution by a processor, cause the processor to implement the operations of the method of synchronizing a plurality of media files.

Other principal features and advantages of the invention will become apparent to those skilled in the art upon review of the following drawings, the detailed description and the appended claims.

### BRIEF DESCRIPTION OF THE DRAWINGS

Exemplary embodiments of the invention will hereafter be described with reference to the accompanying drawings, wherein like numerals denote like elements.

FIG. 1 depicts a block diagram of a media processing system in accordance with an exemplary embodiment.

FIG. 2 depicts a block diagram of a user device capable of using the media processing system of FIG. 1 in accordance with an exemplary embodiment.

FIG. 3 depicts a flow diagram illustrating exemplary operations performed in creating layer content in accordance with an exemplary embodiment.

FIGS. 4-14 depict a user interface of a layer creator application in accordance with a first exemplary embodiment.

FIGS. 15-20 depict a presentation user interface of a layer creator application and/or a media player application in accordance with an exemplary embodiment.

FIG. 21 depicts a presentation user interface of a layer creator application and/or a media player in accordance with a second exemplary embodiment.

FIGS. 22-26 depict a presentation user interface of a layer creator application in accordance with a second exemplary embodiment.

### DETAILED DESCRIPTION

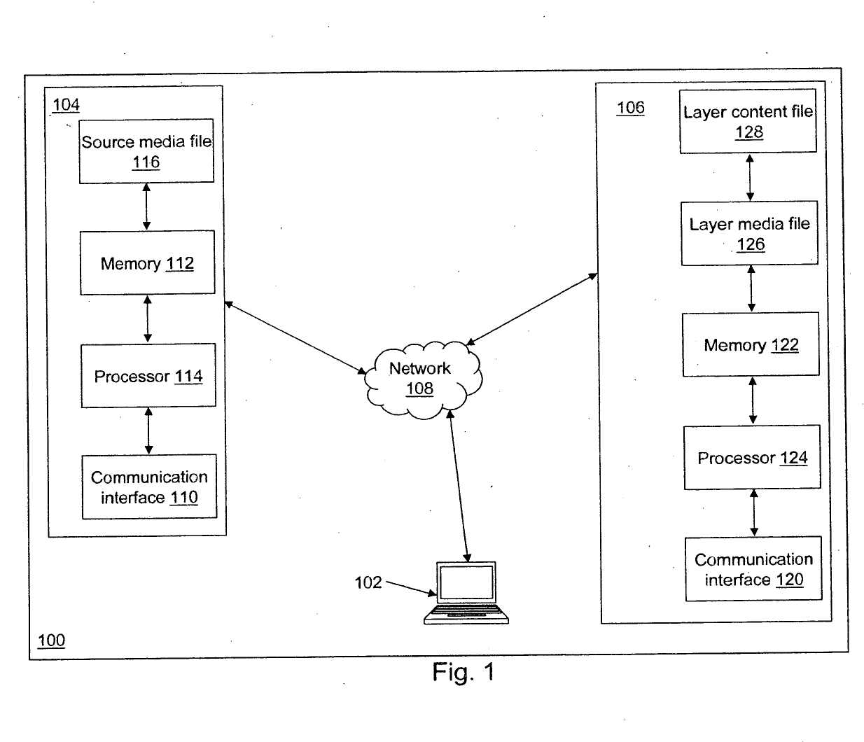

With reference to FIG. 1, a block diagram of a media processing system 100 is shown in accordance with an exemplary embodiment. Media processing system 100 may include a user device 102, a media file source device 104, and a layer file device 106. User device 102, media file source device 104, and layer file device 106 each may be any type of computing device including computers of any form factor such as a laptop, a desktop, a server, etc., an integrated messaging device, a personal digital assistant, a cellular telephone, an iPod, etc. User device 102, media file source device 104, and layer file device 106 may interact using a network 108 such as a local area network (LAN), a wide area network (WAN), a cellular network, the Internet, etc. In an alternative embodiment, user device 102, media file source device 104, and layer file device 106 may be connected directly. For example, user device 102 may connect to layer file device 106 using a cable for transmitting information between user device 102 and layer file device 106.

A computing device may act as a web server providing information or data organized in the form of websites accessible over a network. A website may comprise multiple web pages that display a specific set of information and may contain hyperlinks to other web pages with related or additional information. Each web page is identified by a Uniform Resource Locator (URL) that includes the location or address of the computing device that contains the resource to be accessed in addition to the location of the resource on that computing device. The type of file or resource depends on the internet application protocol. For example, the Hypertext Transfer Protocol (HTTP) describes a web page to be accessed with a browser application. The file accessed may be a simple text file, an image file, an audio file, a video file, an executable, a common gateway interface application, a Java applet, an active server page, or any other type of file supported by HTTP. In an exemplary embodiment, media file source device 104 and/or layer file device 106 are web servers. In another exemplary embodiment, media file source device 104 and/or layer file device 106 are peers in a peer-to-peer network as known to those skilled in the art. In an exemplary embodiment, media file source device 104 and layer file device 106 are the same device. In another exemplary embodiment, user device 102, media file source device 104, and/or layer file device 106 are the same device.

Media file source device 104 may include a communication interface 110 , a memory 112, a processor 114, and a source media file 116. Different and additional components may be incorporated into media file source device 104. For example, media file source device 104 may include a display or an input interface to facilitate user interaction with media file source device 104. Media file source device 104 may include a plurality of source media files. The plurality of source media files may be organized in a database of any format. The database may be organized into multiple databases to improve data management and access. The multiple databases may be organized into tiers. Additionally, the database may include a file system including a plurality of source media files. Components of media file source device 104 may be positioned in a single location, a single facility, and/or may be remote from one another. For example, the plurality of source media files may be located at different computing devices accessible directly or through a network.

Communication interface 110 provides an interface for receiving and transmitting data between devices using various protocols, transmission technologies, and media as known to those skilled in the art. The communication interface may support communication using various transmission media that may be wired or wireless. Media file source device 104 may have one or more communication interfaces that use the same or different protocols, transmission technologies, and media.

Memory 112 is an electronic ho ding place or storage for information so that the information can be accessed by processor 114 as known to those skilled in the art. Media file source device 104 may have one or more memories that use the same or a different memory technology. Memory technologies include, but are not limited to, any type of RAM, any type of ROM, any type of flash memory, etc. Media file source device 104 a so may have one or more drives that support the loading of a memory media such as a CD or DVD or ports that support connectivity with memory media such as flash drives.

Processor 114 executes instructions as known to those skilled in the art The instructions may be carried out by a special purpose computer, logic circuits, or hardware circuits. Thus, processor 114 may be implemented in hardware, firmware, software, or any combination of these methods. The term “execution” is the process of running an application or the carrying out of the operation ca ed for by an instruction. The instructions may be written using one or more programming language scripting language, assembly language, etc. Processor 114 executes an instruction, meaning that it performs the operations called for by that instruction. Processor 114 operably couples with communication interface 110 and with memory 112 to receive, to send, and to process information. Processor 114 may retrieve a set of instructions from a permanent memory device and copy the instructions in an executable form to a temporary memory device that is generally some form of RAM. Media file source device 104 may include a plurality of processors that use the same or a different processing technology.

Source media file 116 includes electronic data associated with the presentation of various media such as video, audio, text, graphics, etc. to a user. Additionally a hyperlink to any other digital source including a web page, other digital media, audio material, graphics, textual data, digital files, geographic information system data really simple syndication (RSS) feeds, etc. can be included in source media file 116. Source media file 116 is generally associated with a type of media player capable of interpreting the electronic data to present the desired content to a user. Thus, source media file 116 may have a variety of formats as known to those skilled in the art.

Layer file device 106 may include a communication interface 120, a memory 122, a processor 124, and a layer media file 126. Different and additional components may be incorporated into layer file device 106. For example, layer file device 106 may include a display or an input interface to facilitate user interaction with layer fi device 106. Layer file device 106 may include a plurality of layer media files. The plurality of layer media files may be organized in one or more databases, which may further be organized into tiers. Additionally, the database may include a fie system including a plurality of layer media files. Components of layer file device 106 may be positioned in a single location, a single facility, and/or may be remote from one another. For example, the plurality of layer media files may be located at different computing devices accessible directly or through a network.

Communication interface 120 provides an interface for receiving and transmitting data between devices using various protocols, transmission technologies, and media as known to those skilled in the art. The communication interface may support communication using various transmission media that may be wired or wireless. Layer file device 106 may have one or more communication interfaces that use the same or different protocols transmission technologies, and media.

Memory 122 is an electronic holding place or storage for information so that the information can be accessed by processor 124 as known to those skilled in the art. Layer file device 106 may have one or more memories that use the same or a different m emory technology. Layer file device 106 also may have one or more drives that support the loading of a memory media such as a CD or DVD or ports that support connectivity with memory media such as flash drives.

Processor 124 executes instructions as known to those ski led in the art The instructions may be carried out by a special purpose computer, logic circuits, or hardware circuits. Thus, processor 124 may be implemented in hardware, firmware, software, or any combination of these methods. The term “execution” is the process of running an application or the carrying out of the operation called for by an instruction. The instructions may be written using one or more programming language, scripting language, assembly language, etc. Processor 124 executes an instruction, meaning that it performs the operations called for by that instruction. Processor 124 operably couples with communication interface 120 and with memory 122 to receive, to send, and to process information. Processor 124 may retrieve a set of instructions from a permanent memory device and copy the instructions in an executable form to a temporary memory device that is generally some form of RAM. Layer file device 106 may include a plurality of processors that use the same or a different processing technology

Layer media file 126 includes electronic data associated with the presentation of various media such as video, audio, text, graphics to a user as a layer over source media file 116. Additionally, a hyperlink to any other digital source including a web page, other digital media, audio material, graphics, textual data, digital files, geographic information system data, RSS feeds, etc. can be included in layer media file 126. Thus, layer media file 126 can be interactive, can operate as a hyper ink, and can be updated in real-time. For example, when watching a movie, a user can select an object in the movie causing a web page to open with a sales price for the object or causing entry into a live auction for the object. Additionally, instead of the user actively looking for content, content may be “pushed” to the viewer. The pushed content may be in any form and may be informational, functional, commercial such as advertising, etc.

Layer media file 126 is enabled to playback as an over ay to source media file 116. Layer media file 126 is generally associated with a type of media player capable of interpreting the electronic data to present the desired content to a user. Thus, layer media file 126 may have a variety of formats as known to those skilled in the art. In an exemplary embodiment, a layer media file is an extensible markup language (XML) based file extracted from a database which identifies the necessary data required to display a layer in a transparent media player positioned above and in ratio with the source media file(s). The data captured in layer media file 126 and used to create a layer over the source media file(s) may include: (a) a source object containing information concerning the source layer, such as the source of the content layer, an origin of the content layer, and a name of the content layer (b) a layer object containing information concerning the layer, such as a creator of the layer, creation and update dates of the layer, a type of layer, and a description of the layer; (c) an object of a layer which for example, can be comic-style bubbles, an impression, a subtitle, an image, an icon, a movie or video file, an audio file, an advertisement, an RSS or other live feed, etc.; (d) information concerning a user who may be a creator or a viewer, and (e) a group of layers linked together by a common base or inked together by a user request. In an exemplary embodiment, a layer content file 128 may be created which contains content such as video, audio, graphics, etc. which is referenced from layer media file 126 as the object of the layer.

The transparent player communicates with the layer database, for example using the hypertext transport protocol Simple Object Access Protocol, and XML, allowing automatic injection of the layer, or layers, and the layers' objects to add the additional information on the source object which identifies a source media file or files. The automatic injection of the layer, or layers, can be performed based on various parameters including keywords a layer object type, timing, etc. Layer media files are created by a layer creator allowing the background playback of the source media file and the addition of layers and layer objects on-the-fly, setting object type, text, inks, and timing. The layer creator automatically synchronizes user requests with the layers database. An exemplary XML file to support use of the transparent p layer is shown below.

<dsPlyServer xmlns=“http://82.80.254.38/dsPlyServer.xsd”>

<Bubble>

<bid>9c1647f3-ec55-4d03-8fac-8dc6915d5f29</bid>
<pid>5d9833a8-5797-4355-9d06-0c3e6d0250fc</pid>
<BubbleFormat_id>5</BubbleFormat_id>
<strBubbleText>sgsh$$TextKeeper$$</strBubbleText>
<dblTop>0.24</dblTop>
<dblLeft>0.25</dblLeft>
<dblWidth>117.50</dblWidth>
<dblHeight>66.45</dblHeight>
<tipX>0.28</tipX>
<tipY>0.59</tipY>
<OutlineWidth>1</OutlineWidth>
<hexColor>0x0</hexColor>
<fontColor>0xf7f8f8</fontColor>
<dtTimeLine>4.00</dtTimeLine>
<dtPeriod>3.00</dtPeriod>
<strUrlText />
<strUrl />
<bolVisible>true</bolVisible>
<dblAlpha>50.00</dblAlpha>
<bolShadow>false</bolShadow>
<strAnimationPath />
<dtCreationDate>2007-03-19T20:15:36.857+02:00</dtCreationDate>
<dtLastUpdate>2007-03-19T20:16:13.17+02:00</dtLastUpdate>
<UpdateBy>d5999850-5ad6-4466-8b17-814969c059b3</UpdateBy>

</Bubble>
<Bubble>

. . .

<strBubbleText>http://www.bubbleply.com/clip_art/stars.swf$$TextKeeper$$</strBubbleText>

. . .

</Bubble>
<Bubble>

. . .

<strAnimationPath>Bubble#**#false#**#214.25@180.25#**#164.25@145.5#**#164.25@76#**

#301@41.25#**#0@0#**#0@0#**#</strAnimationPath>
. . .

</Bubble>
<Bubble>

. . .

<BubbleFormat_id>1</BubbleFormat_id>
<strBubbleText>click

me$$TextKeeper$$color#0xff#0#5@url#http://www.bubbleply.com/Navigate.aspx?bid=6646e6a2-
9b5a-4bd9-9d34-95f21b2e0046&uid=a8a58ff7-a43a-4c67-aa6b-
19a4e2ace005&embed=undefined&url=http%3A%2F%2Fwww%2Egoogle%2Ecom#0#7@color#0xff6
6#6#7@size#48#0#7@</strBubbleText>
. . .

</Bubble>

</dsPlyServer>

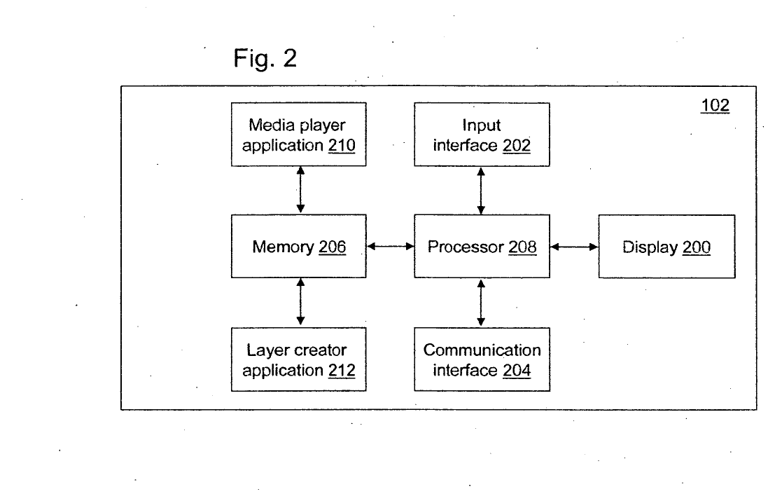

With reference to FIG. 2, user device 102 may include a display 200, an input interface 202, a communication interface 204, a memory 206, a processor 208, a media player application 210, and a layer creator application 212. Different and additional components may be incorporated into user device 102. For example, user device 102 may include speakers for presentation of audio media content. Display 200 presents information to a user of user device 102 as known to those skilled in the art. For example, display 200 may be a thin film transistor display, a light emitting diode display, a liquid crystal display, or any of a variety of different displays known to those skilled in the art now or in the future.

Input interface 202 provides an interface for receiving information from the user for entry into user device 102 as known to those skilled in the art. Input interface 202 may use various input technologies including, but not limited to, a keyboard a pen and touch screen, a mouse, a track ball, a touch screen, a keypad, one or more buttons, etc. to allow the user to enter information into user device 102 or to make selections presented in a user interface displayed on display 200. Input interface 202 may provide both an input and an output interface. For example, a touch screen both allows user input and presents output to the user.

Communication interface 204 provides an interface for receiving and transmitting data between devices using various protocols, transmission technologies, and media as known to those skilled in the art. The communication interface may support communication using various transmission media that may be wired or wireless. User device 102 may have one or more communication interfaces that use the same or different protocols, transmission technologies, and media.

Memory 206 is an electronic holding place or storage for information so that the information can be accessed by processor 208 as known to those skilled in the art. User device 102 may have one or more memories that use the same or a different memory technology. User device 102 a so may have one or more drives that support the loading of a memory media such as a CD or DVD or ports that support connectivity with memory media such as flash drives.

Processor 208 executes instructions as known to those skilled in the art. The instructions may be carried out by a special purpose computer, logic circuits, or hardware circuits. Thus, processor 208 may be implemented in hardware, firmware, software or any combination of these methods. The term “execution” is the process of running an application or the carrying out of the operation called for by an instruction. The instructions may be written using one or more programming language, scripting language, assembly language, etc. Processor 208 executes an instruction, meaning that it performs the operations called for by that instruction. Processor 208 operably couples with display 200, with input interface 202, with communication interface 204, and with memory 206 to receive, to send, and to process information. Processor 208 may retrieve a set of instructions from a permanent emory device and copy the instructions in an executable form to a temporary memory device that is generally some form of RAM. User device 102 may include a plurality of processors that use the same or a different processing technology.

Media player application 210 performs operations associated with presentation of media to a user. Some or all of the operations and interfaces subsequently described may be embodied in media player application 210. The operations may be implemented using hardware, firmware, software, or any combination of these methods. With reference to the exemplary embodiment of FIG. 2, media player application 210 is implemented in software stored in memory 206 and accessible by processor 208 for execution of the instructions that embody the operations of media player application 210. Media player application 210 may be written using one or more programming languages, assembly languages, scripting languages, etc.

Layer creator application 212 performs operations associated with the creation of a layer of content to be played over a source media file. Some or all of the operations and interfaces subsequently described may be embodied in layer creator application 212. The operations may be implemented using hardware, firmware, software, or any combination of these methods. With reference to the exemplary embodiment of FIG. 2 layer creator application 212 is implemented in software stored in memory 108 and accessible by processor 110 for execution of the instructions that embody the operations of layer creator application 212. Layer creator application 212 may be written using one or more programming languages, assembly languages, scripting languages, etc. Layer creator application 212 may integrate with or otherwise interact with media player application 210.

Layer media file 126 and/or source media file 116 may be stored on user device 102. Additionally, source media file 116 and/or layer media file 106 may be manually provided to user device 102. For example source media file 116 and/or layer media file 106 may be stored on electronic media such as a CD or a DVD. Additionally, source media file 116 and/or layer media file 106 may be accessible using communication interface 204 and a network.

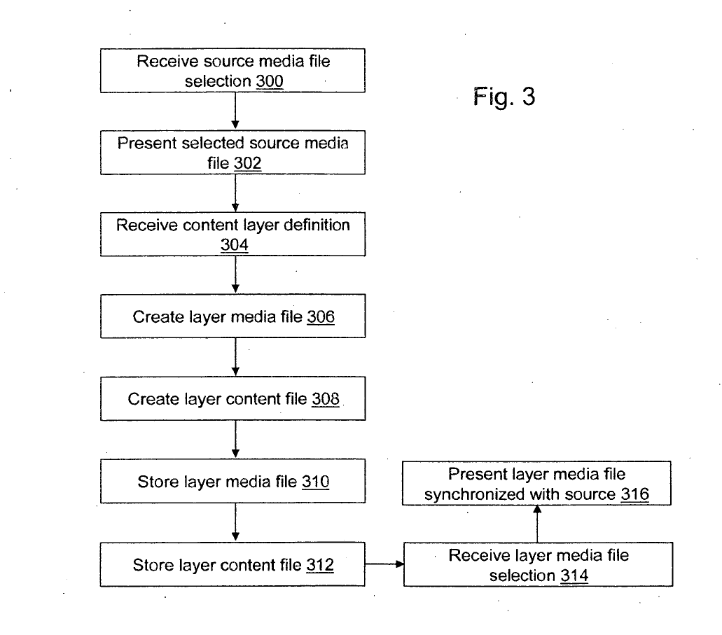

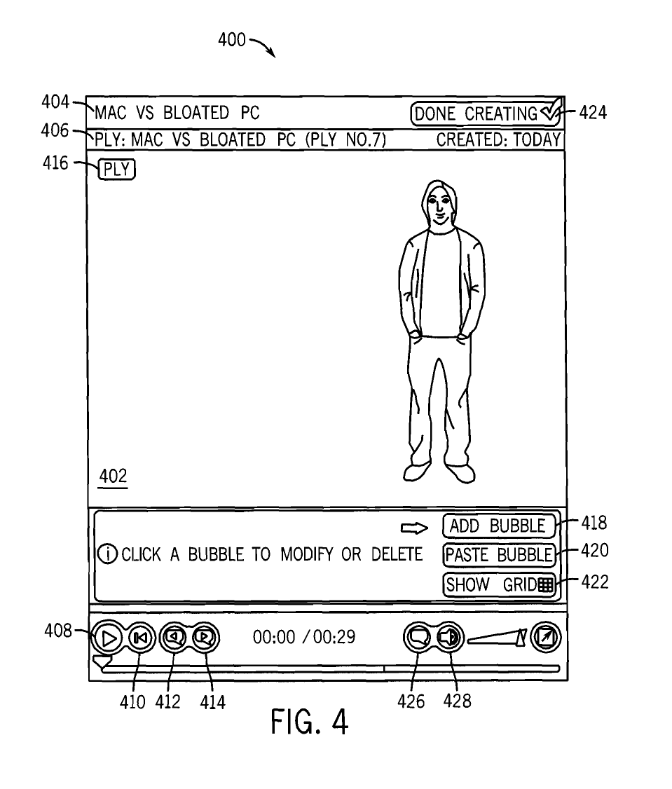

With reference to FIG. 3, exemplary operations associated with layer creator application 212 of FIG. 2 are described. Additional, fewer, or different operations may be performed, depending on the embodiment. The order of presentation of the operations is not intended to be limiting. In an operation 300, layer creator application 212 receives a source media file selection from a user. For example, the user may select a source media file by entering or selecting a ink to the source media file using a variety of methods known to those ski ad in the art. As another example player creator application 212 is called when the user selects the link, but the source media file is already identified based on integration with the source media file ink. The source media file may be located in memory 206 of user device 102 or on media file source device 104. In an operation 302, the selected source media file is presented. For example, the user may select a play button or the selected source media file may automatically start playing. In an operation 304, a content layer definition is received. For example, with reference to FIG. 4, a user interface 400 of layer creator application 212 is shown in accordance with an exemplary embodiment.

In the exemplary embodiment of FIG. 4, user interface 400 includes a viewing window 402, a source file identifier 404, a layer identifier 406 a play/pause button 408, a rewind button 410, a previous content button 412, a next content button 414, a first content switch 416, an add content button 418, a paste content button 420, a show grid button 422, a completion button 424, a second content switch 426, and a mute button 428. The media content is presented to the user in viewing window 402. Source file identifier 404 presents a name of the selected source media file. Layer identifier 406 presents a name of the layer media file being created by the user as a layer over the selected source media file. User selection of play/pause button 308 toggles between playing and pausing the selected media. User selection of rewind button 410 causes the selected media to return to the beginning. User selection of previous content button 412 causes the play of the selected media to return to the last layer content added by the user for overlay on the selected source media file. User selection of next content button 414 causes the play of the selected media to skip to the next layer content added by the user for overlay on the selected source media file. User selection of first content switch 416 turns off the presentation of the layer content created by the user. User selection of add content button 418 causes the presentation of additional controls which allow the user to create new content for over ay on the selected source media file. User selection of paste content button 420 pastes se acted content into viewing window 402 for overlay on the se acted source media file. User selection of show grid button 422 causes presentation of a grid over viewing window 402 to allow the user to precise y place content objects. User selection of second content switch 426 turns off the presentation of the layer content created by the user. User selection of mute button 428 causes the sound to be muted.

As the user interacts with user interface 400, the created content objects are received and captured. User selection of completion button 424 creates a content layer definition. For example, with continuing reference to FIG. 3, in an operation 306 layer media file 126 is created. In an operation 308, a layer content fie may be created which contains the layer content, for example, in the form of a video or audio file. In an operation 310, the created layer media file is stored. The created layer media file may be stored at user device 102 and/or at layer file device 106. In an operation 312, if created, the created layer content file is stored, for example, in a database. The created layer content file may be stored at user device 102 and/or at layer file device 106. In an operation 314, a request to present the created layer media file is received. For example, the user may select the created layer media file from a drop down box, from a link, etc. In an operation 316, the layer media file is presented to the user in synchronization and overlaid on the selected source media file.

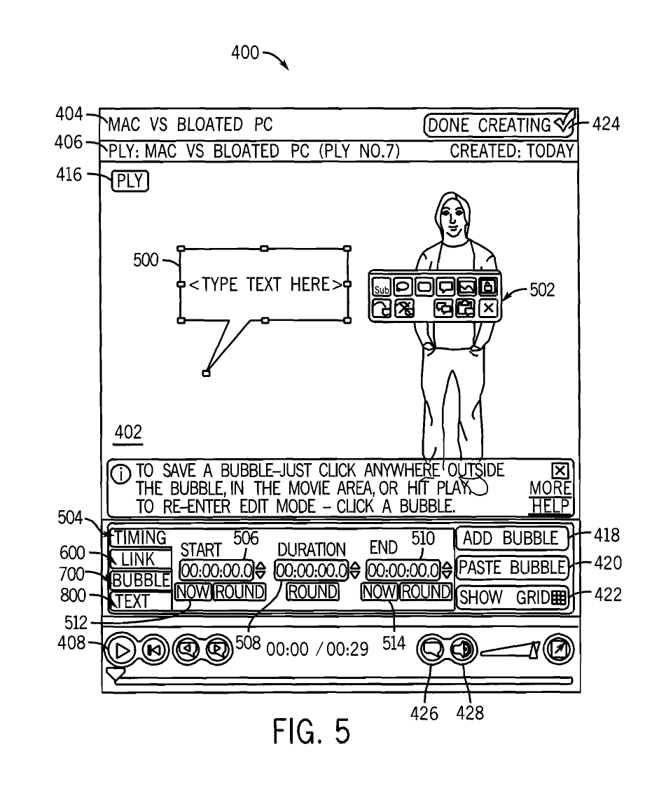

With reference to FIG. 5, user interface 400 is presented, in an exemplary embodiment, after receiving a user selection of add content button 418. In the exemplary embodiment of FIGS. 4-8, the content is related to text boxes of various types which can be overlaid on the source media file. User selection of add content button 418 causes inclusion of additional controls in user interface 400. The additional controls for adding content may include a text box 500, a first control menu 502, a timing control menu 504, a link menu 600, a box characteristic menu 700, and a text characteristic menu 800. A user may enter text in text box 500 which is overlaid on the selected source media file. In an exemplary embodiment, first control menu 502 includes a plurality of control buttons which may include a subtitle button, a thought button, a commentary button, and a speech button which identify a type of text box 500 and effect the shape and/or default characteristics of text box 500

First control menu 502 also may include a load image button, an effects button, an animate button, and a remove animation button, which allow the user to add additional effects associated with text box 500. First control menu 502 further may include a copy button, a paste button, and a delete button to copy, paste, and delete, respectively, text box 500. The user may resize and/or move text box 500 within viewing window 402. Timing control menu 504 may include a start time control 500, a duration control 508, and an end time control 510 which allow the user to determine the time for presentation of text box 500. The user may also select a start time and an end time while the selected source media file is playing using a start button 512 and a stop button 514.

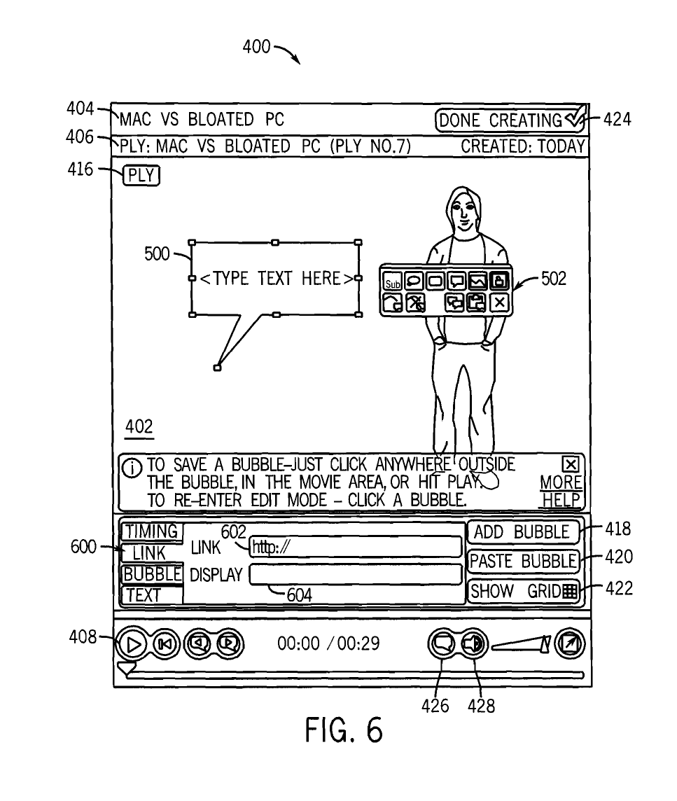

With reference to FIG. 6, user interface 400 is presented, in an exemplary embodiment, including link menu 600. Link menu 600 may include a ink text box 602 and a display text box 604. The user enters a link in link text box 602. The user enters the desired display text associated with the ink in display text box 604.

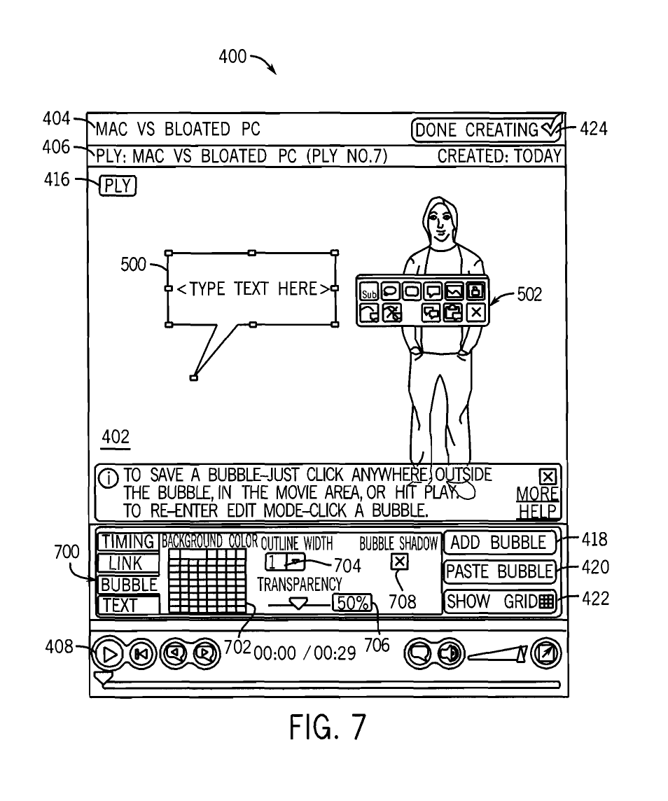

With reference to FIG. 7, user interface 400 is presented, in an exemplary embodiment, including box characteristic menu 700 which allows the user to define the characteristics of text box 500. Box characteristic menu 600 may include a color selector 702, an outline width selector 704, a transparency selector 706, and a shadow selector 708.

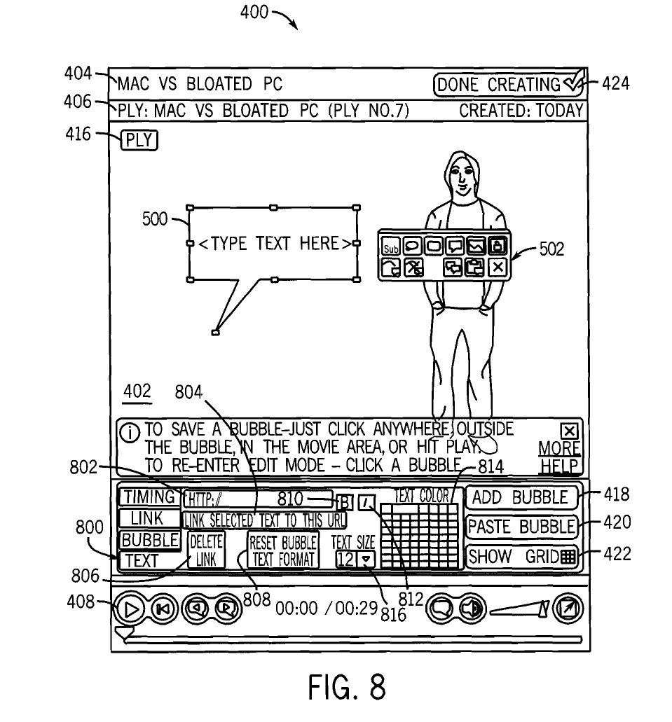

With reference to FIG. 8, user interface 400 is presented, in an exemplary embodiment, including text characteristic menu 700 which allows the user to define the characteristics of the text in text box 500. Text characteristic menu 700 may include a ink text box 802, a link button 804, a delete link button 806, a reset button 808, a bold button 810, an italic button 812, a text color selector 814, and a text size selector 816. The user enters a link in link text box 802. The user may associate the entered ink with text selected in text box 500 by selecting the text and link button 804. User selection of delete ink button 806 removes the link associated with the selected text. User selection of reset button 808 resets the text characteristics of text box 500 to the previous values.

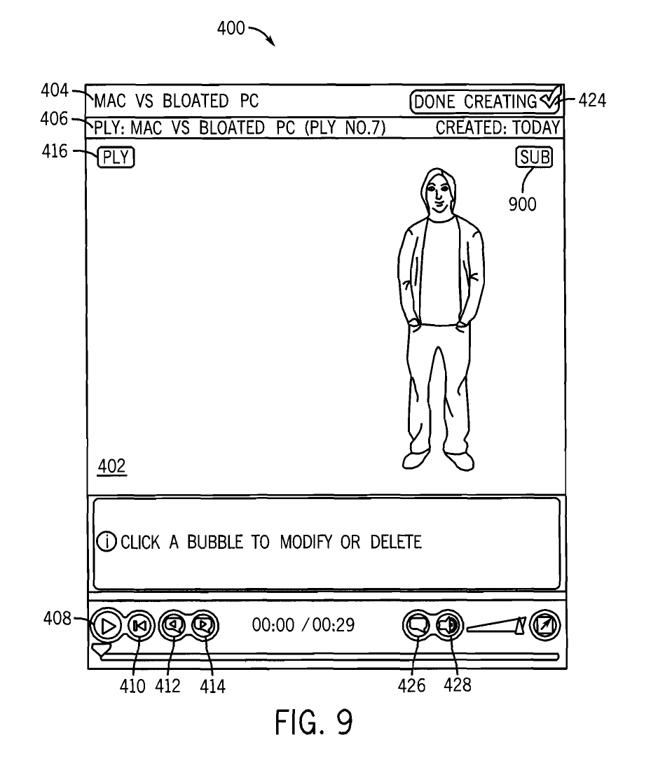

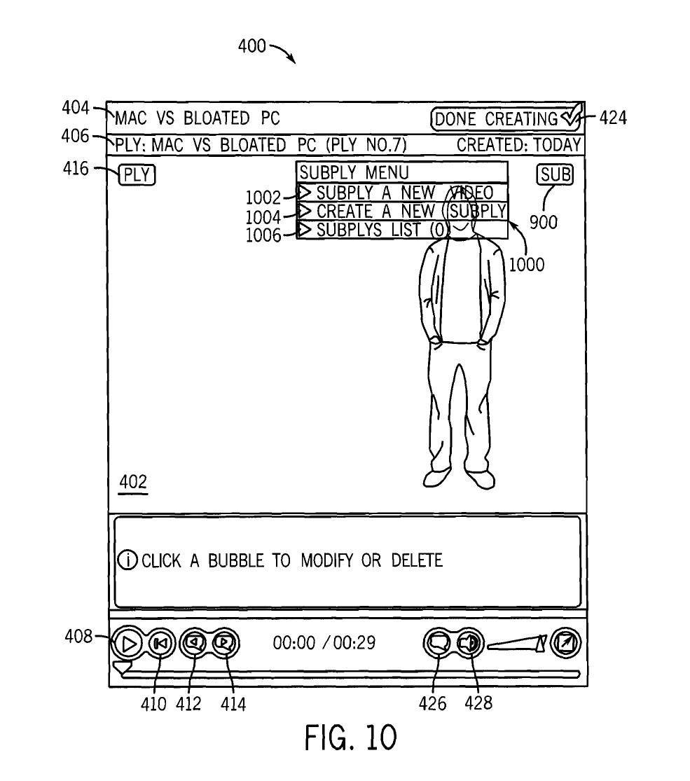

With reference to FIG. 9, user interface 400 of layer creator application 212 is shown in accordance with a second exemplary embodiment. In the exemplary embodiment of FIG. 9 user interface 400 includes a second content switch 900. In the exemplary embodiment of FIGS. 9-14, the content is related to subtitles. With reference to FIG. 10, user interface 400 is presented, in an exemplary embodiment, after receiving a user selection of second content switch 900. User selection of second content switch 900 causes presentation of a content menu 1000 in an exemplary embodiment, content menu 1000 includes a new video option 1002, a new subtitle option 1004, and a subtitle list option 1006.

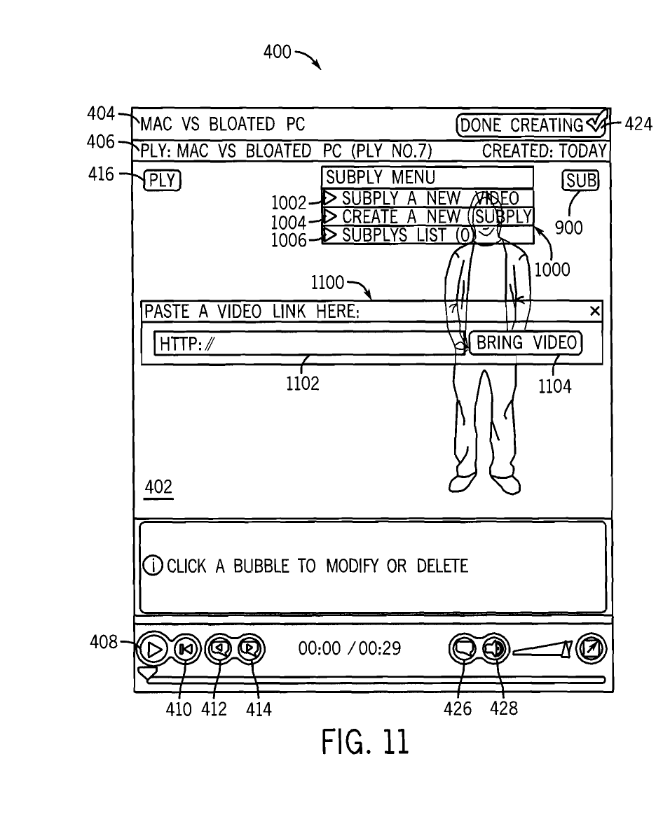

With reference to FIG. 11, user interface 400 is presented, in an exemplary embodiment, after receiving a user se action of new video option 1002 and includes a source media file selection window 1100. Source media file selection window 1100 may include a ink text box 1102 and a select button 1104. The user enters a link to a source media file in ink text box 1102. User selection of select button 1104 causes presentation of the selected source media file to which subtitles are to be added.

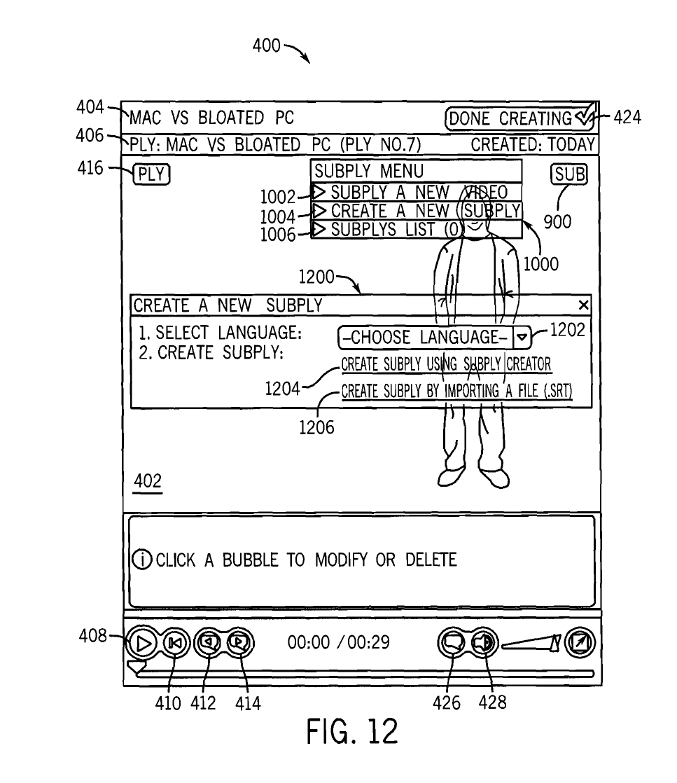

With reference to FIG. 12, user interface 400 is presented in an exemplary embodiment, after receiving a user selection of new subtitle option 1004 and includes a subtitle creation window 1200. Subtitle creation window 1200 may include a language selector 1202, a subtitle creator link 1204, and an import subtitle file ink 1206. User selection of subtitle creator ink 1204 causes presentation of a subtitle creator. User selection of import subtitle file fink 1206 causes importation of a file which contains the subtitles.

With reference to FIG. 13 user interface 400 is presented in an exemplary embodiment after receiving a user selection of subtitle list option 1006 and includes a subtitle list window 1200. Subtitle list window 1200 may include a subtitle switch 1302 and a subtitle list 1304. User selection of subtitle switch 1302 toggles the presentation of subtitles on or off depending on the current state of the subtitle presentation. Viewing window 402 includes subtitles 1306 overlaid on the selected source media file when the state of subtitle switch 1302 is “on”. Subtitle list 1304 includes a list of created subtitles associated with the selected source media file. For each created subtitle subtitle list 1304 may include a language, an author, and a creation date or modification date. The user may select the subtitles overlaid on the source media file from subtitle list 1304.

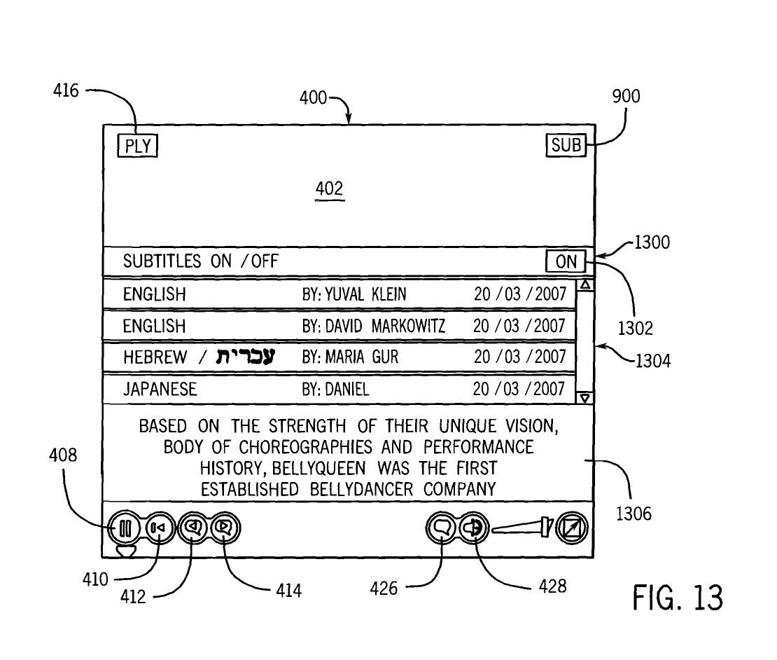

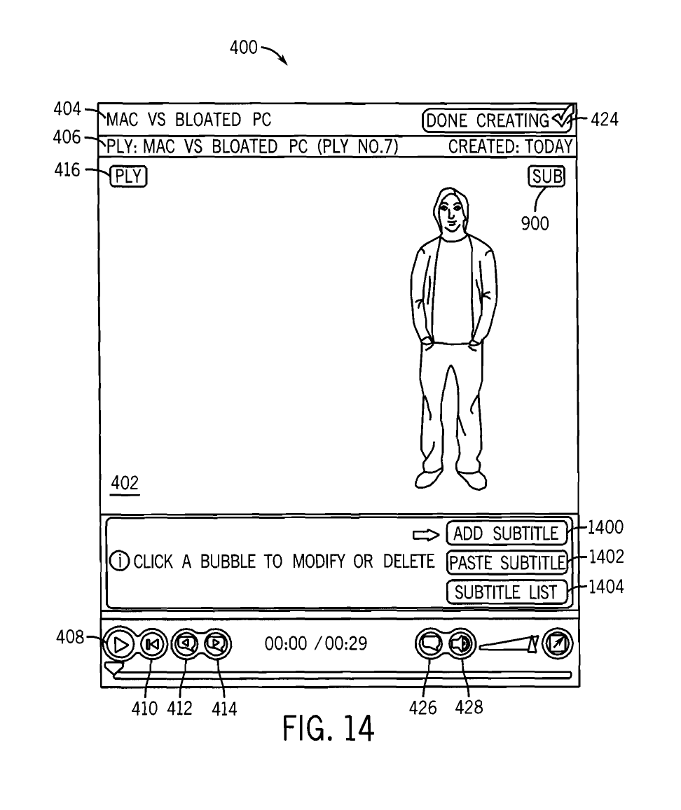

With reference to FIG. 14, user interface 400 is presented, in an exemplary embodiment, after receiving a user selection of subtitle creator link 1204. User selection of subtitle creator ink 1204 causes inclusion of additional controls in user interface 400 for creating subtitles. For example, the subtitle creator may have similar capability to that shown with reference to FIGS. 4-8 such that subtitles can be created and modified. The additional controls for adding content may include an add subtitle button 1400 a paste subtitle button 1402, and a subtitle list button 1404. User selection of add subtitle button 1400 causes the presentation of additional controls which allow the user to create new subtitles for overlay on the selected source media file. User selection of paste subtitle button 1404 pastes a selected subtitle into viewing window 402 for overlay on the selected source media file. User selection of subtitle list button 1404 causes the presentation of a list of subtitles created for overlay on the selected source media file.

As shown in FIG. 1, a layered video including source media file 116 and layer media file 126 can be distributed to others using various mechanisms as known to those skilled in the art. Presentation of source media file 116 and layer media file 126 is synchronized such that the content of the files is presented in parallel at the same time and rate enabling a viewer to experience both the added content provided through layer media file 126 and source media file 116 together as if viewing only one media file.

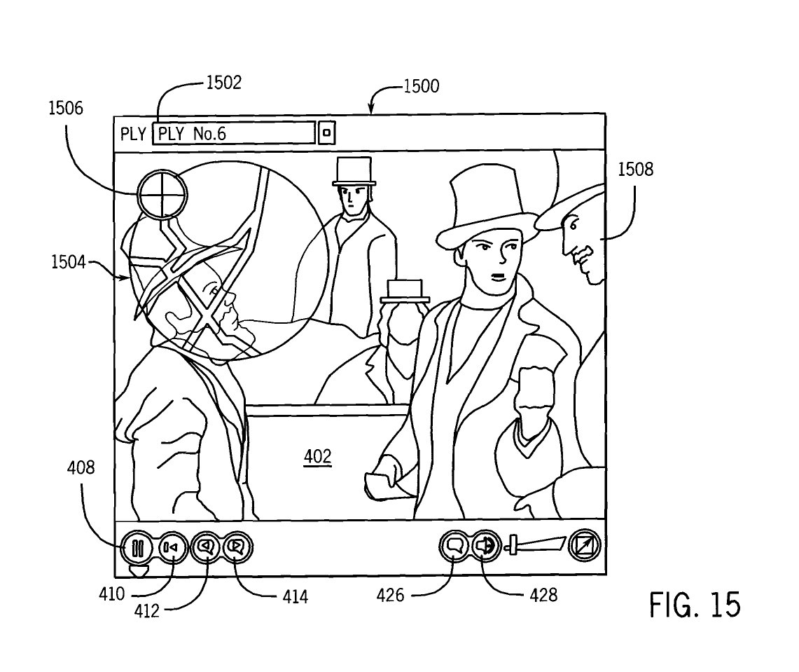

With reference to FIG. 15, a presentation user interface 1500 of layer creator application 212 and/or media player application 210 is shown in accordance with a first exemplar embodiment. In the exemplary embodiment of FIG. 15, presentation user interface 1500 includes viewing window 402, a layer file selector 1502 pay/pause button 408, rewind button 410, previous content button 412, next content button 414, second content switch 426, and mute button 428 in an exemplary embodiment layer file selector 1502 may be a drop down menu including a list of available layer media files, for example, created using layer creator application 212. Layer selector 1502 may be a text box which allows the user to enter a location of layer media file 126. For example, the user may enter a file system location if layer media file 126 is stored locally or a URL if layer media file 126 is accessed using network 108. As another alternative, the user may select layer media file 126 directly from a file system of user device 102 or from a webpage.

Presentation user interface 1500 presents a source media file 1508 in viewing window 402. Synchronized with presentation of the source media file is a layer 1504 which includes a map and a location indicator 1506. The physical location of various objects in the source media file such as buildings, streets, cities, shops, parks, etc mentioned or presented may be displayed on the map. A search results page a so may be presented in addition to options for maps to view

With reference to FIG. 16, viewing window 402 of layer creator application 212 and/or media player application 210 is shown in accordance with a second exemplary embodiment. In the exemplary embodiment of FIG. 16, viewing window 402 includes a source media file 1600 synchronized with presentation of a first text box 1602 and a second text box 1604 included in the selected layer media file 126 First text box 1602 and second text box 1604 may have been created as described with reference to FIGS. 4-8. Second text box 1604 includes text 1606 and a link 1608. User selection of link 1608, for example, may cause presentation of a web page, other digital media, audio material, graphics, textual data, digital files, geographic information system data, really simple syndication (RSS) feeds, etc.

Text boxes also may be used to indicate information to a viewer such as who the actors on the screen are, what previous movies they have played in, etc. When an actor leaves the screen, their name disappears from the actor list. The actor list may include links to additional information related to the actor.

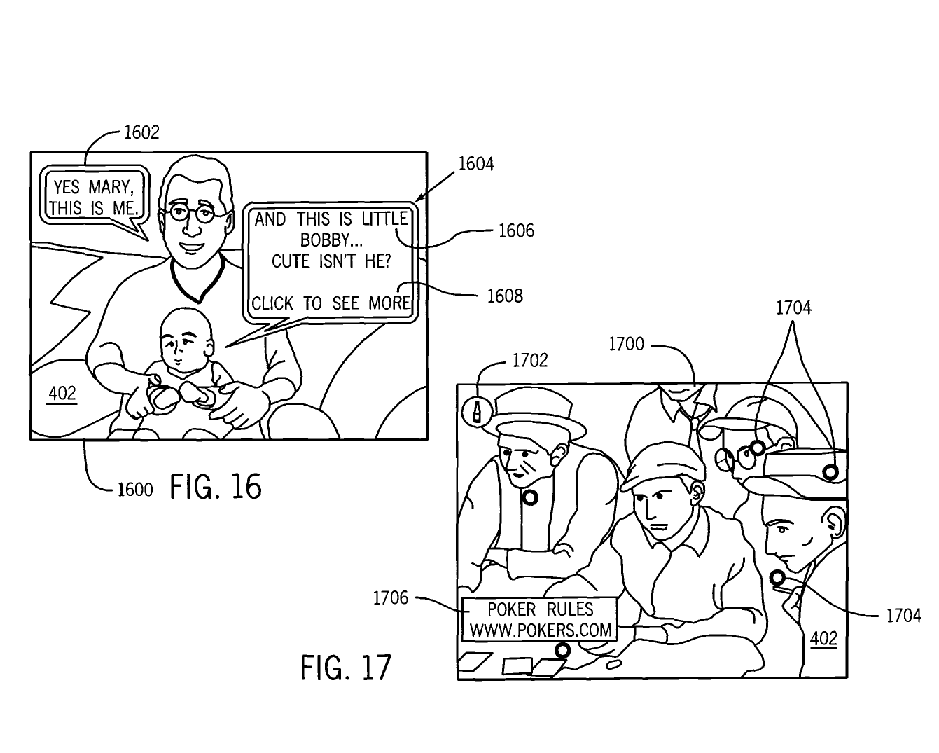

With reference to FIG. 17, viewing window 402 of layer creator application 212 and/or media player application 210 is shown in accordance with a third exemplary embodiment. In the exemplary embodiment of FIG. 17, viewing window 402 includes a source media file 1700 synchronized with presentation of a graphic 1702 and hotspots 1704. The graphic 1702 may represent an advertisement. In the exemplary embodiment of FIG. 17, hotspots 1704 are indicated with red dots. When a user rolls a mouse over a hotspot, a box 1706 appears with content and/or a hyperlink. Keywords can be tagged to source media file 1700 by associating them with hotspots 1704. Using a keyword search feature, the location of a word in source media file 1700 can be identified. Sponsored advertisements (direct advertisements or advertisements generated through affiliate programs) can be created to appear during playback of source media file 1700. Graphic 1702 also may include a hyperlink which opens a new webpage with more details related to the product, service, company, etc.

In another exemplary embodiment, using subtitled text, the system can analyze and se a word or series of words or placement of words within the video (based on time, frame, and/or geographic data of the viewer) and enable the subtitled text to be automatically hyperlinked to direct the user to a webpage defined by the advertiser. The same can be done with text or words generated from any of the content created on layer media file 126. In yet another exemplary embodiment, based on generated words, tags, images, or any content created in the video, a transparent layer can be added to the video (again, based on time, frame, and/or geographic elements of the viewer) whereby a viewer can click anywhere on the video and be directed to a webpage defined by the advertiser. Such advertisements can be made visible or invisible to the user. For example, the user may select a hyperlink which becomes a layer itself presented under the source media file so that when the source media file ends or the user stops it, the new layer of content appears. Additionally, the user can ca up the layer to view at any time. The layer may be an advertisement that relates to the source media file and appears with or without user request.

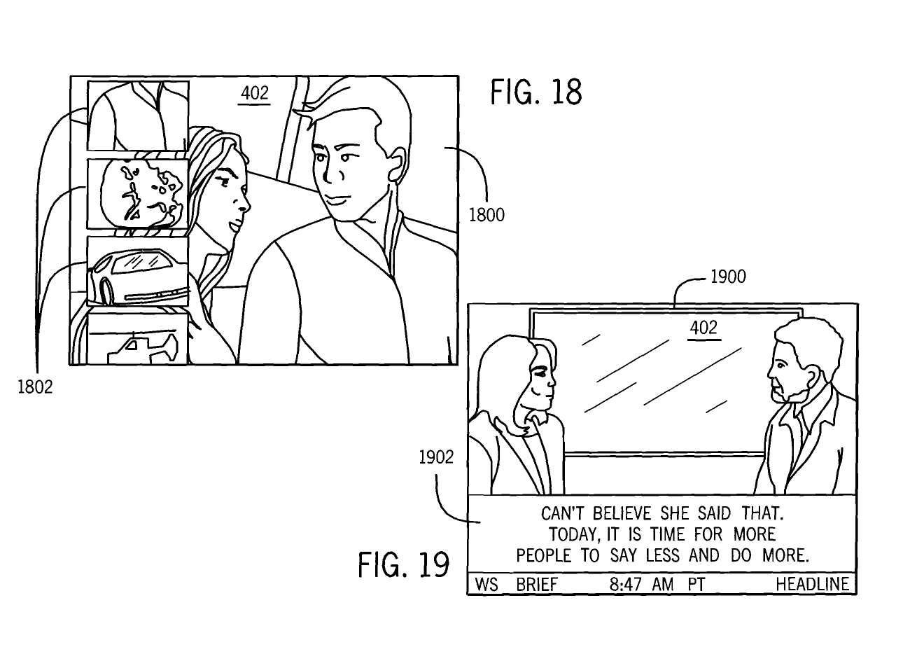

With reference to FIG. 18, viewing window 402 of layer creator application 212 and/or media player application 210 is shown in accordance with a fourth exemplary embodiment. In the exemplary embodiment of FIG. 18, viewing window 402 includes a source media fie 1800 synchronized with presentation of one or more product windows 1802. Product windows 1802 allow the user to see where products mentioned, used, seen, or worn in source media file 1800 can be purchased. Product windows 1802 may include a graphic of the product and a hyperlink which, after selection opens a new webpage containing additional details related to the product. Products can be identified based on a category, a company name, a product name, an object name, etc. Product windows 1802 can be associated with a hyper-link in real-time allowing for time-related sales or auctions to be linked to a product.

With reference to FIG. 19, viewing window 402 of layer creator application 212 and/or media player application 210 is shown in accordance with a fifth exemplary embodiment n the exemplary embodiment of FIG. 19, viewing window 402 includes a source media file 1900 synchronized with presentation of commentary 1902 added to a video weblog broadcast.

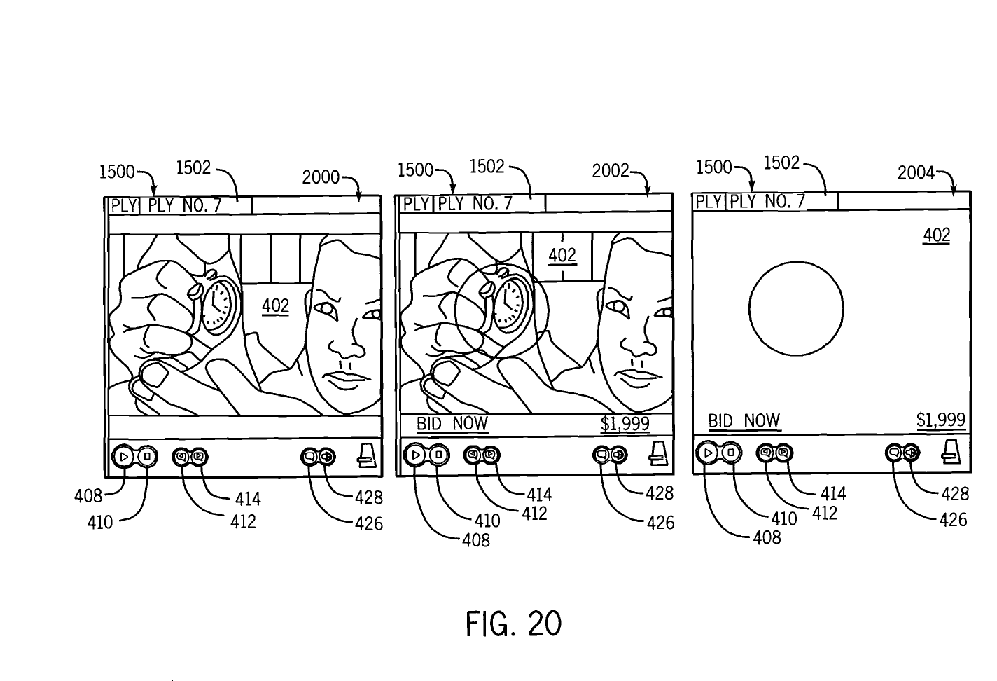

A plurality of layer media files may be presented with source media file 116. Additionally, source media file 116 and/or layer media file 126 can be presented together or independently. For example, with reference to FIG. 20, in a first window 2000, only the source media file is presented. The selection status of second content switch 426 is “off”. User selection of second content switch 426 causes presentation of the source media file and the overlaid layer content as shown in second window 2002. In a third window 2004, only the layer content is presented

To support synchronization between the presentation of layer media file 126 and of source media file 116, a reference parameter is selected that may be associated with layer media file 126 and/or source media file 116. For example, the Windows® Media Player contains a WindowMediaPlayer1.Ctlcontrols.currentPosition property which indicates the amount of time that has elapsed for the currently displayed media file. By tracking the elapsed time of layer media file 126 and/or source media file 116, the other file or files can be control ed to display the relevant information or content at the intended and appropriate time. For example, the reference parameter from which layer media file 126, source media file 116, and other media files are displayed may be a time-elapsed event and/or a frame-elapsed event. Use of the reference parameter supports maintenance of the synchronization between the media files despite, for example, buffering during file streaming that may cause presentation of one media file to slow relative to the other.

As an example without imitation, during playback of source media file 116, layer media file 126 may contain information that is scheduled to appear during the 76^{th} second of source media file 116 and which should only be displayed when the 75^{th} second of source media file 116 has elapsed. Should the playback of source media file 116 be delayed or stopped such that the 76^{th} second is not reached or is slow relative to real-time, the applicable portion of layer media file 126 is also delayed or slowed to maintain synchronization between the media files.

A frame-related event may also be used as the reference parameter by which the media files are synchronized. In cases where source media file 116 is stored or encoded using different “frame per second” intervals, layer media file 126 (or Vice versa) may be converted to play using the same “frame per second” interval as source media file 116 thus allowing for synchronization between the files.

Testing of the reference parameter may be implemented such that source media file 116 is synchronized with layer media file 126, such that layer media file 126 is synchronized with source media file 116, or both. Testing of the reference parameter may be performed based on any periodic interval such that the testing of the reference parameter is performed “on the fly”. Thus, the synchronization process may be performed as the media files are received and not prior to transmission. The location of both layer and source files is extracted and compared to halt one or the other files until the timing position of both layer and media files are again synchronized. Source media files may be stored using different formats and may store ti ming data using various methods. Each format's p layer is used as a timing reference or the source media file itself is analyzed.

Additionally, a contextual understanding of source media file 116 can be developed using the metadata associated with layer media file 126. For example, an algorithm may analyze the information in the XML file created to define the content of the layer overlaid on source media file 116. Based on this analysis, additional external layers of content related to the content of source media file 116 can be synchronized to the presentation of the content of source media file 116. In an exemplary embodiment, the additional external layers of content can be real time content feeds such as RSS feeds. The content can be real time enabled and synchronized to the content of source media file 116 based on the analysis of the metadata of layer media file 126. For example the metadata analysis may indicate that the video content of source media file 116 includes elements of finance and weather. As a result, a real time feed of financial data can be synchronized to the part of source media file 116 that talks about finance, and real time weather information can be synchronized to the part of source media file 116 that refers to weather. Thus, real time content can be presented as another layer media file 126 on source media file 116. The real time content can be presented both in synchronization with source media file 116 and in synchronization with a contextual understanding of source media file 116. In an exemplary embodiment the algorithm analyses the metadata using keywords and relationships between keywords as known to those skilled in the art.

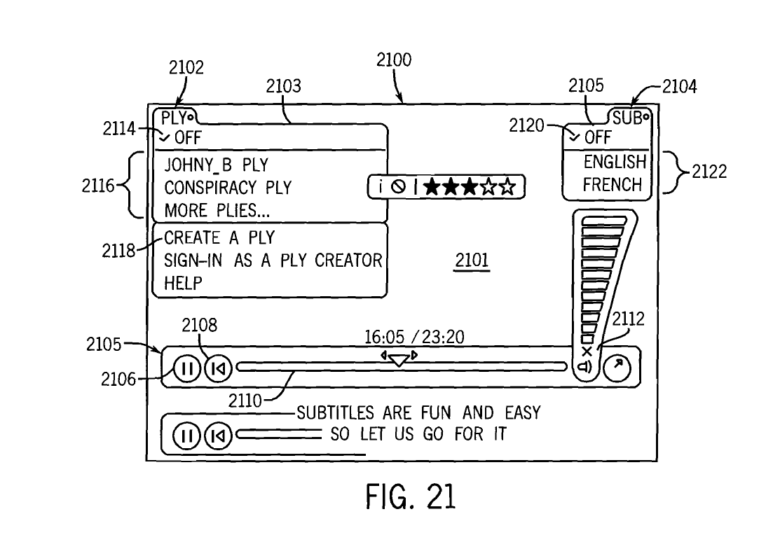

With reference to FIG. 21 a user interface 2100 of layer creator application 212 and/or media player 210 is shown in accordance with a second exemplary embodiment n the exemplary embodiment of FIG. 21 user interface 2100 includes a viewing window 2101 a layer content selection button 2102 a subtitle selection button 2104 and a control bar 2105. The media content is presented to the user in viewing window 2101. Control bar 2105 includes controls associated with media player functionality and appears on viewing window 2101 when a user scrolls over viewing window 2101. Control bar 2105 includes a play/pause button 2106 a rewind bu ton 2108 a time bar 2110 a volume button 2112 etc. User selection of play/pause button 2106 toggles between playing and pausing the selected media. User selection of rewind button 2108 causes the selected media to return to the beginning. User selection of volume button 2112 allows the user to mute the sound increase the volume of the sound and/or decrease the volume of the sound.

User selection of layer content selection button 2102 causes presentation of a layer menu 2103. Layer menu 2103 may include an on/off selection 2114 a list of layers 2116 created for the selected source media file 116 and a create layer selection 2118. User selection of on/off selection 2114 toggles on/off the presentation of the layer content created by a user. In an exemplary embodiment layer content selection button 2102 indicates an on/off status of the layer selection and/or a no layer selected status for example with a colored dot colored text etc. The user may switch the layer content presented by making a selection from the list of layers 2116. User selection of create layer selection 2118 causes the presentation of additional controls which allow the user to create new content for over ay on the selected source media file 116.

User selection of subtitle selection button 2104 causes presentation of a subtitle menu 2105. Subtitle menu 2105 may include an on/off selection 2120 and a list of subtitle layers 2122 created for the selected source media file 116. User selection of on/off selection 2120 toggles on/off the presentation of the subtitle layer created by a user. In an exemplary embodiment, subtitle selection button 2104 indicates an on/off status of the subtitle selection and/or a no subtitle selected status, for example with a colored dot, colored text, etc. The user may switch the subtitle layer presented by making a selection from the list of layers 2122. Each subtitle layer may be associated with a language. A subtitle layer may be created using create layer selection 2118.

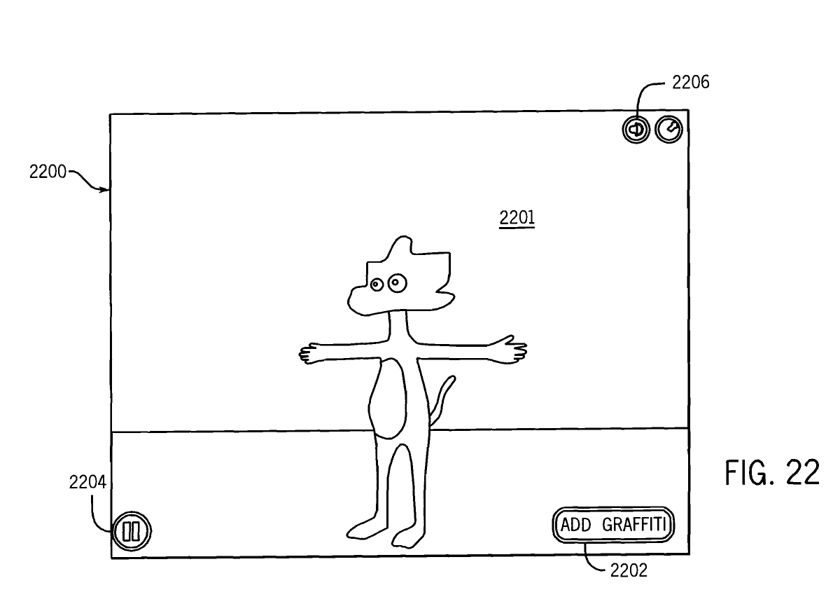

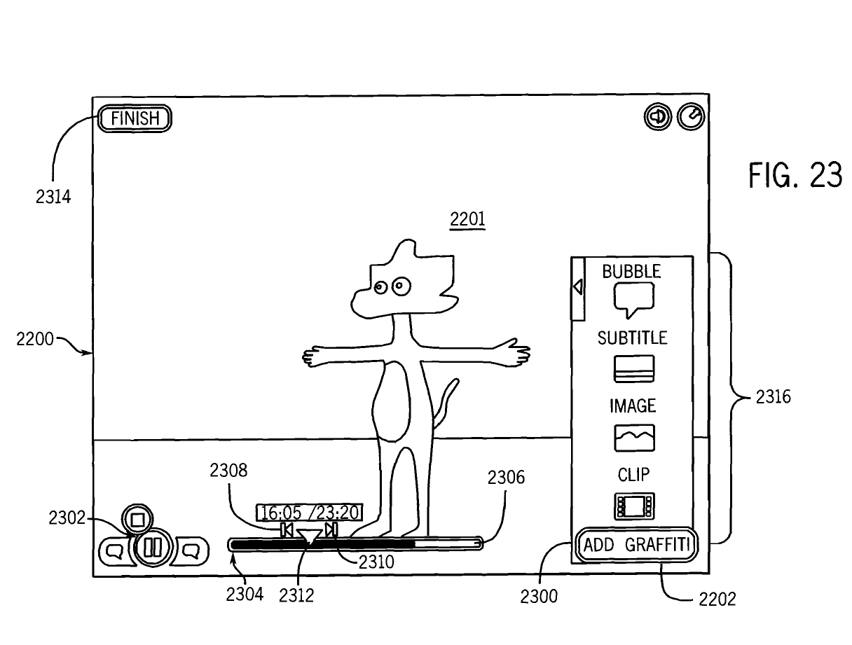

With reference to FIG. 22, user interface 2200 is presented, in an exemplary embodiment, after receiving a user selection of create layer selection 2118. User interface 2200 includes a viewing window 2201, an add content button 2202, a play/pause button 2204, and a volume button 2206. The media content is presented to the user in viewing window 2201. With reference to FIG. 23, user selection of add content button 2202 causes inclusion of additional controls in user interface 2200. The additional controls for adding content may include a first control menu 2300, video play controls 2302, a timing control bar 2304, and a completion button 2314. First control menu 2300 includes a list of content types 2316. Exemplary content types include a thought/commentary bubble, a subtitle, an image, and a video clip. Video play controls 2302 may include a play/pause button, a stop button, a skip backward to previous layer content button, a skip forward to next layer content button, etc.

Timing control bar 2304 allows the user to adjust the start time, stop time, and/or duration of the presentation of the layer content over the selected source media file 116. Timing control bar 2304 may include a time bar 2306, a start content arrow 2308, a stop content arrow 2310, and a current presentation time indicator 2312. The user may drag star content arrow 2308 and/or stop content arrow 2310 along time bar 2306 to modify the start/stop time associated with presentation of the created content. The user selects completion button 2314 when the creation of the content layer is complete. User selection of completion button 2314 creates a content layer definition. For example, with reference to FIG. 3, in an operation 300 layer media file 126 is created. In an operation 308, a layer content file ay be created which contains the layer content, for example, in the form of a video or audio file.

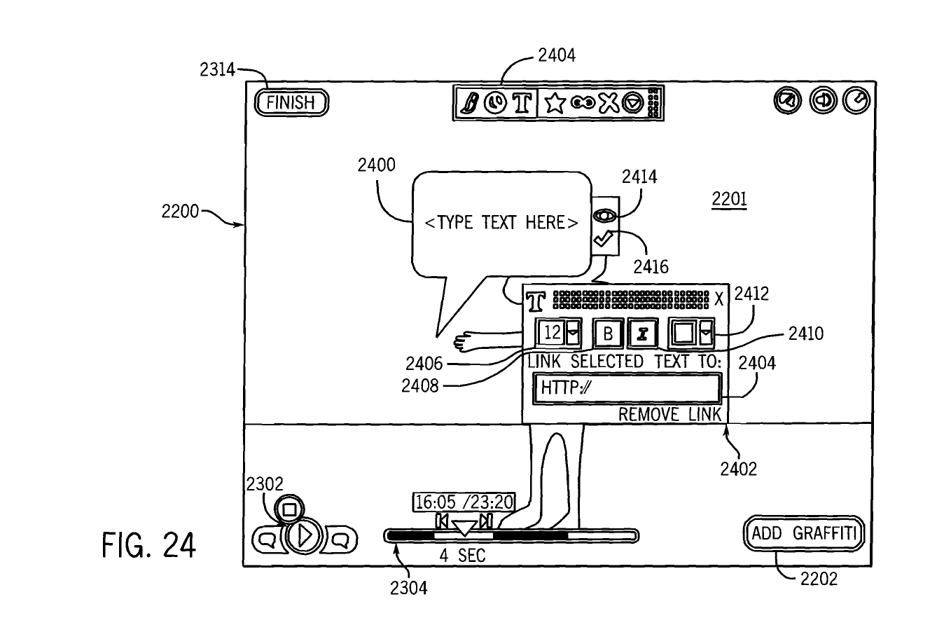

With reference to FIG. 24, user interface 2200 is presented, in an exemplary embodiment, for example, after receiving a user selection of a thought commentary bubble from the list of content types 2316. In the exemplary embodiment of FIGS. 24-26, the content is related to text boxes of various types which can be overlaid on the source media file. User selection of a content type from the list of content types 2316 causes inclusion of additional controls in user interface 2200. The additional controls for adding content may include a text box 2400, a text characteristic menu 2402, a control menu 2404, a preview button 2414, and a save button 2416. A user may enter text in text box 2400 which is overlaid on the selected source media file. The user may resize and/or move text box 2400 within viewing window 2201. Timing control bar 2304 allows the user to adjust the start time, stop time, and/or duration of the presentation of text box 2400 over the selected source media file 116. User selection of preview button 2414 causes presentation of the created content layer over the selected media file for review by the user. User selection of save button 2416 saves the created content layer as a content layer definition.

Control menu 2404 includes a plurality of control buttons which may include a change appearance button, a timing button, a text characteristic button, a text button, a link button, a delete button, a copy button, a paste button, an effects button, an animate button, etc. Selection of a change appearance button allows the user to change the type of text box 2400 and effects the shape and/or default characteristics of text box 2400. Text characteristic menu 2402 allows the user to define the characteristics of the text in text box 2400. Text characteristic menu 2402 may appear after user selection of a text characteristic button from control menu 2404. Text characteristic menu 2402 may include a link text box 2404, a text size selector 2406, a bold button 2408, an italic button 2410, and a text color selector 2412. The user enters a link in link text box 2404.

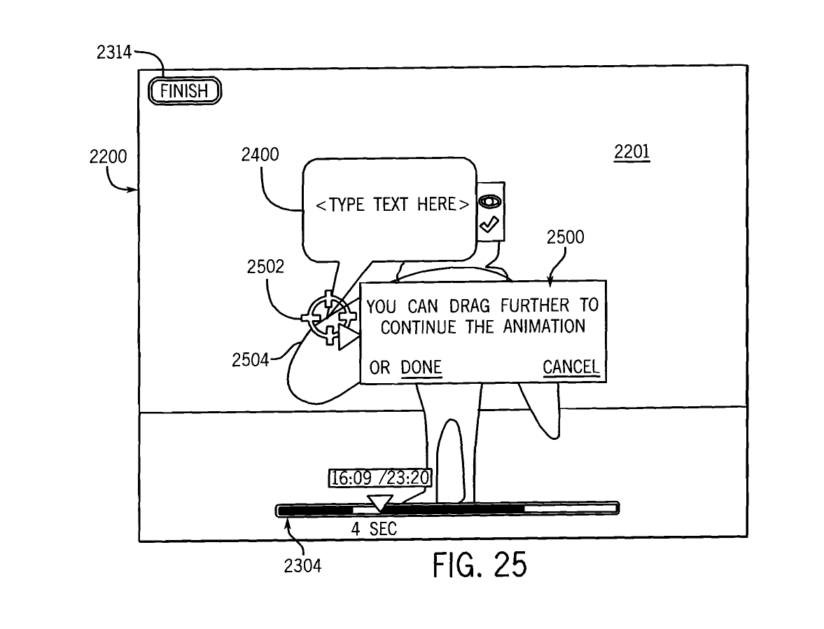

With reference to FIG. 25, user interface 2200 is presented in an exemplary embodiment, for example, after receiving a user selection of an animate button from control menu 2404. User selection of a control button from control menu 2404 causes inclusion of additional controls in user interface 2200. The additional controls for animating content may include a control box 2500 a position cursor 2502, and an animation path 2504. Control box 2500 may include a completion button and a cancel button. The user selects position cursor 2502 and drags position cursor 2502 to define animation path 2504. When the content layer is presented over the selected source media file 116, the content follows animation path 2504 defined by the user.

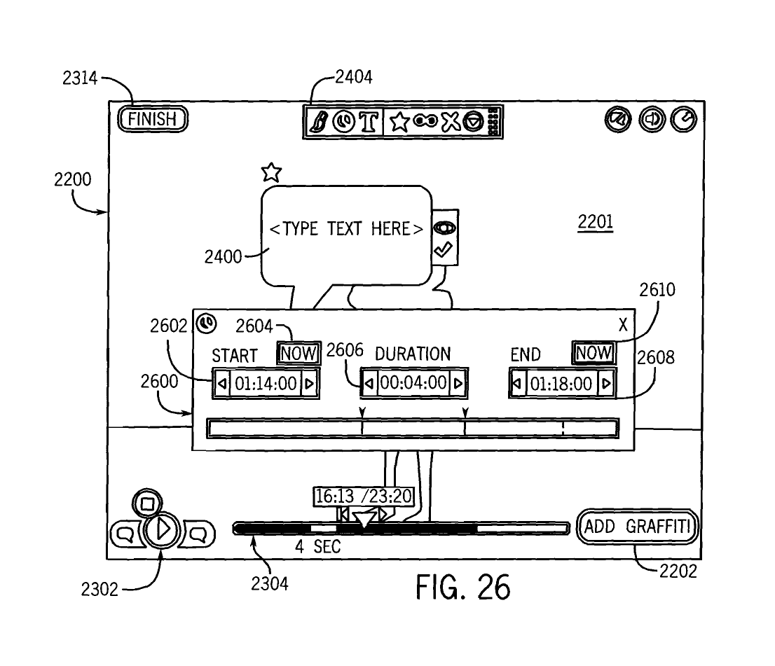

With reference to FIG. 26, user interface 2200 is presented, in an exemplary embodiment, for example, after receiving a user selection of a timing button from control menu 2404. User selection of a control button from control menu 2404 causes inclusion of additional controls in user interface 2200. The additional controls for controlling timing of presentation of the content may include a control box 2600. Control box 2500 may include a start timer 2602, a start now button 2604, a duration timer 2606, a stop timer 2608, and a stop now button 2610. The user can adjust the start time for the presentation of the content layer using start timer 2602 which may include a text box for entering a time and/or a backward arrow and a forward arrow for adjusting the time backward or forward, respectively. The user can select a start time while the selected media source file is presented using start now button 2604. The user can adjust the duration of the presentation of the content layer using duration timer 2606 which may include a text box for entering a time and/or a backward arrow and a forward arrow for adjusting the time backward or forward, respectively. The user can adjust the stop time for the presentation of the content layer using stop timer 2608 which may include a text box for entering a time and/or a backward arrow and a forward arrow for adjusting the time backward or forward, respectively. The user can select a stop time while the selected media source file is presented using stop now button 2610

The word “exemplary” is used herein to mean serving as an example, instance, or illustration. Any aspect or design described herein as “exemplary” is not necessarily to be construed as preferred or advantageous over other aspects or designs. Further, for the purposes of this disclosure and unless otherwise specified, “a” or “an” means “one or more”. The exemplary embodiments may be implemented as a method, apparatus, or article of manufacture using standard programming and/or engineering techniques to produce software, firmware, hardware, or any combination thereof to control a computer to implement the disclosed embodiments. The term “computer readable medium” can include, but is not limited to, magnetic storage devices (erg., hard disk, floppy disk, magnetic strips, . . . ), optical disks (e.g., compact disk (CD), digital versatile disk (DVD), . . . ), smart cards flash memory devices, etc. Additionally, it should be appreciated that a carrier wave can be employed to carry computer-readable media such as those used in transmitting and receiving electronic mail or in accessing a network such as the Internet or a local area network (LAN). The network access may be wired or wireless.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The functionality described may be implemented in a single executable or application or may be distributed among modules that differ in number and distribution of functionality from those described herein. Additionally the order of execution of the functions may be changed depending on the embodiment. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1 . A device for presenting and synchronizing a plurality of media files, the device comprising:
a communication interface, the communication interface receiving a first media file;
a computer-readable medium having computer-readable instructions stored therein which are programmed to
present a second media file with the first media file,
while the second media file is presented with the first media file, compare a first reference parameter associated with the first media file to a second reference parameter associated with the second media file; and
control the presentation of the second media file with the first media file based on the comparison to synchronize the second media file and the first media file; and
a processor, the processor coupled to the communication interface and to the computer-readable medium and configured to execute the instructions.

2. A computer-readable medium including computer-readable instructions that, upon execution by a processor, cause the processor to synchronize a plurality of media files, the instructions configured to cause a computing device to:
receive a first media file from a first device;
present a second media file with the first media file;
while presenting the second media file with the first media file, compare a first reference parameter associated with the first media file to a second reference parameter associated with the second media file; and
control the presentation of the second media file with the first media file based on the comparison to synchronize the second media file and the first media file.

3. A method of synchronizing a plurality of media files, the method comprising:
receiving a first media file from a first device at a second device;
presenting a second media file with the first media file at the second device;
while presenting the second media file with the first media file, comparing a first reference parameter associated with the first media file to a second reference parameter associated with the second media file; and
controlling the presentation of the second media file with the first media file based on the comparison to synchronize the second media file and the first media file.

4. The method of claim 3, wherein the first media file is a source media file.

5. The method of claim 4, wherein the source media file is presented in a viewing window using a media player application.

6. The method of claim 5, wherein the second media file is a layer media file presented in a transparent media player positioned over the viewing window

7. The method of claim 6, wherein the transparent media player is positioned in ratio with the viewing window.

8. The method of claim 6, wherein a control of the transparent media player is positioned in the viewing window.

9. The method of claim 6, wherein the layer media file includes a reference to a location of the source media file.

10. The method of claim 3, wherein the first media file is a layer media file capable of presentation over the second media file.

11. The method of claim 10, wherein the layer media file includes media selected from the group consisting of video, audio, text, one or more graphic, one or more hotspot, one or more map, one or more video weblog broadcast, one or more animation, and one or more hyperlink to one or more digital source.

12. The method of claim 11, wherein the one or more digital source includes a web page, video, audio, text, one or more graphic, geographic information system data, and a really simple syndication feed.

13. The method of claim 3, further comprising receiving the second media file from a third device at the second device.

14. The method of claim 3, wherein presenting the second media file with the first media file comprises overlaying the second media file on the first media file.

15. The method of claim 3, wherein presenting the second media file with the first media file comprises overlaying the first media fie on the second media file.

16. The method of c aim 3, wherein the first reference parameter is selected from the group consisting of one or more time and one or more frame rate.

17. The method of claim 3, further comprising:
while resenting the second media file with the first media file, comparing a third reference parameter associated with the first media file to a fourth reference parameter associated with the second media file;
wherein controlling the presentation of the second media file with the first media file is further based on comparing the third reference parameter to the fourth reference parameter.

18. The method of claim 3, wherein controlling the presentation of the second media file with the first media file synchronizes the second media file with the first media file.

19. The method of claim 3, wherein controlling the presentation of the second media file with the first media file comprises executing an algorithm to analyze metadata of a third media file to synchronize the second media file with the first media file.

20. The method of claim 3, wherein the first device is the second device.

21. The method of claim 3, further comprising
while presenting the second media file with the first media file, receiving a third media file from a third device at the second device and
presenting the third media file with the first media file and the second media file at the second device;
wherein presenting the second media file with the first media file comprises overlaying the second media file on the first media file; and
further wherein presenting the third media file with the first media file and the second media file comprises overlaying the first media file on the third media file.
